(19) United States
(12) Patent Application Publication
(10) Pub. No.: US 2012/0228957 A1
(43) Pub. Date: Sep. 13, 2012

(54) WIRELESS POWER TRANSFER APPARATUS

(76) Inventor: Yasushi MIYAUCHI, Kyoto (JP)

(21) Appl. No.: 13/412,864

(22) Filed: Mar. 6, 2012

(30) Foreign Application Priority Data
Mar. 7, 2011 (JP) 2011-049167

(51) Int. Cl. H02J 17/00

(52) U.S. Cl. 307/104

(57) ABSTRACT

A wireless power transfer apparatus includes a power transmission coil configured to transfer an electric power to a power receiver having a power receiving coil. The apparatus further includes: a housing that holds the power transmission coil and forms an interior in which the power receiver can be placed removably; a lid provided for opening and closing the interior; and an electromagnetic shield encompassing the power transmission coil and the power receiving coil at least when an electric power is transferred. An electric power is transferred with the lid of the housing being closed. This configuration suppresses a possibility that a part of the energy transmitted from the power transmission coil is not received by the power receiving coil, so as to be radiated and leak out during the power transfer.

### BACKGROUND OF THE INVENTION

1. Field of the Invention

The present invention relates to a wireless power transfer device that transfers power wirelessly through a power transmission coil provided in a power transmitter and a power receiving coil provided in a power receiver.

2. Description of Related Art

As methods of wireless power transfer, an electromagnetic induction type (several hundred kHz), electric or magnetic-field resonance type using transfer based on LC resonance through electric or magnetic field resonance, a microwave transmission-type using radio waves (several GHz), and a laser transmission-type using electromagnetic waves (light) in the visible radiation range are known. Among them, the electromagnetic induction type has already been used practically. Although this method is advantageous, for example, in that it can be realized with simple circuitry (a transformer), it also has the problem of a short power transmission distance.

Therefore, the electric or magnetic field resonance-type power transfer methods recently have been attracting attention, because of an ability of a short-distance transfer (up to 2 m). Among them, in the electric field resonance type method, when placing the hand or the like in a transfer path, a dielectric loss is caused, because the human body, which is a dielectric, absorbs energy as heat. In contrast, in the magnetic field resonance type method, the human body hardly absorbs energy and a dielectric loss thus can be avoided. From this viewpoint, the magnetic field resonance type method attracts an increasing attention.

FIGS. 26A and 26B each show an exemplary arrangement of a plurality of power transmission coils used in resonance type wireless power transfer. FIG. 26A shows an exemplary arrangement of three power transmission coils 1a to 1c, and FIG. 26B shows an exemplary arrangement of four power transmission coils 1a to 1d. In these examples, the power transmission coils 1a to 1d have the same size and same characteristics. The power transmission coils 1a to 1d may be collectively referred to as the power transmission coils 1.

FIGS. 27A and 27B each show an arrangement of a power receiving coil 3 that receives power. FIG. 27A shows the arrangement of the power receiving coil 3 corresponding to the arrangement of the power transmission coils 1a to 1c shown in FIG. 26A, and FIG. 27B shows the arrangement of the power receiving coil 3 corresponding to the arrangement of the power transmission coils 1a to 1d shown in FIG. 26B. FIG. 28 is a cross-sectional view taken along the line A-A in FIG. 27B.

In order to transfer power by magnetic field resonance, the power transmission coils 1 and the power receiving coil 3 each include a resonance coil, and an electric power is transferred through magnetic field resonance between the resonance coil on the power transmission side and the resonance coil on the power receiving side. As the case may be, for example, a loop coil is disposed adjacent to the resonance coil to feed an electric power to or receive an electric power from the resonance coil. For this reason, the power transmission coil 1 refers to a coil structure on the transmission side including a resonance coil and the power receiving coil 3 refers to a coil structure on the power receiving side including a resonance coil.

When power transfer by magnetic field resonance as above is put into actual use, a several MHz to several hundred MHz frequency may be utilized. During the power transfer, there is a possibility that some of the generated energy transferred from the power transmission coil is not received by the power receiving coil and leaks out. Although the impact of the magnetic field resonance type on the human body is smaller than that of the electric field resonance type, the impact on the human body needs to be taken into consideration depending on the transmission power.

It is also necessary to arrange the power transmission coils 1a to 1d so as not to overlap one another in the same plane. That is, given that the radius of each power transmission coil 1 is “r”, the center-to-center distance between two adjacent coils of the power transmission coils 1 should be 2r or more. Thus, when three power transmission coils are arranged as shown in FIG. 26A or four power transmission coils are arranged as shown in FIG. 26B, a dead center area 2, where the power transfer efficiency decreases, exists near the center of the arrangement of the power transmission coils 1a to 1c or the center of the arrangement of the power transmission coils 1a to 1d. Therefore, if the power receiving coil 3 is arranged at the center of the dead point area as shown in FIGS. 27A, 27B and 28, a decrease in the power transfer efficiency is quite likely to become a problem.

There is a similar problem for an electromagnetic induction-type wireless power transfer apparatus. JP 2009-164293 A discloses a configuration for preventing a decrease in the transfer efficiency resulting from the presence of the dead point area during wireless power transfer from power transmission coils on the primary side to a power receiving coil on the secondary side. A plurality of power transmission coils are used in this configuration and they are arranged so as to overlap one another. For example, when D denotes the diameter of each power transmission coil and X denotes the center-to-center distance between two adjacent coils of the power transmission coils, D and X satisfy D/2≦X≦D. As a result, the configuration is expected to reduce the dead point area in which power cannot be transferred and to allow stable power transfer in a wide range.

For the magnetic field resonance type, however, overlapping of two adjacent power transmission coils leads to a decrease in the transfer efficiency, so that the measure taken for the electromagnetic induction type cannot be adopted. On the other hand, when power transmission coils are arranged in the same plane so as not to overlap one another in the magnetic field resonance type, the dead point area in which power cannot be transferred is likely to exist.

Moreover, when applying to small mobile devices such as portable phones, power transmission coils and power receiving coils need to be reduced in size, which causes a decrease in the possible transmission distance.

### SUMMARY OF THE INVENTION

With the foregoing in mind, a primary object of the present invention is to provide a wireless power transfer apparatus capable of suppressing a possibility that a part of the energy transmitted from the power transmission coil is not received by the power receiving coil, so as to be radiated and leak out during the power transfer.

Further, it is an object of the present invention to provide a wireless power transfer apparatus capable of allowing stable power transfer in a wide range by reducing the area resulting from the presence of a dead point in which power is difficult to be transferred, or by avoiding a decrease in the transmission distance limited by the sizes of the power transmission coils and the power receiving coils.

The wireless power transfer apparatus of the present invention includes a power transmission coil configured to transfer an electric power to a power receiver having a power receiving coil, thereby transferring an electric power to the power receiver through an interaction between the power transmission coil and the power receiving coil.

In order to solve the problems mentioned above, the apparatus of the present invention further includes: a housing that holds the power transmission coil and forms an interior in which the power receiver can be placed removably; a lid provided to the housing so as to open and close the interior with the power receiver being placed; and an electromagnetic shield encompassing the surroundings of the power transmission coil and the power receiving coil at least when an electric power is transferred to the power receiving coil from the power transmission coil. An electric power is transferred to the power receiving coil from the power transmission coil with the lid of the housing being closed.

Because the electromagnetic shield encompasses the surroundings of the power transmission coil and the power receiving coil and the lid of the housing is closed during power transfer, the present invention can prevent electromagnetic waves from leaking out.

### BRIEF DESCRIPTION OF THE DRAWINGS

FIG. 1 is a cross-sectional view showing the configuration of a wireless power transfer apparatus according to Embodiment 1.

FIG. 2 is a plan view showing an exemplary arrangement of a power receiving coil and power transmission coils of the wireless power transmission apparatus.

FIG. 3 is a cross-sectional view showing the positional relationship between the power transmission coil and the power receiving coil for explaining variations in the power transfer efficiency in response to the displacement between the central axis of the power transmission coil and the central axis of the power receiving coil.

FIG. 4 is a graph showing the relationship between the power transfer efficiency and the central axis displacement obtained by experiment based on the arrangement shown in FIG. 3.

FIG. 5 is a cross-sectional view showing an area in which power can be transferred at the maximum efficiency by a conventional wireless power transfer apparatus.

FIG. 6 is a cross-sectional view showing the configuration and actions of the wireless power transfer apparatus according to Embodiment 1.

FIG. 7 is a drawing for explaining the actions of the wireless power transfer apparatus when the central axis of the power receiving coil 3 is in an area A.

FIG. 8 is a drawing for explaining the actions of the wireless power transfer apparatus when the central axis of the power receiving coil 3 is in an area C.

FIG. 9 is a drawing for explaining the actions of the wireless power transfer apparatus when the central axis of the power receiving coil 3 is in an area B.

FIG. 10 is a plan view showing other exemplary arrangement of the power receiving coil and the power transmission coils of the wireless power transmission apparatus according to Embodiment 1.

FIG. 11A is a cross-sectional view showing the configuration and actions of a wireless power transfer apparatus according to Embodiment 2.

FIG. 11B is a plan view of the wireless power transfer apparatus according to Embodiment 2.

FIG. 12 is a cross-sectional view for explaining the configuration of a wireless power transfer apparatus according to Embodiment 3.

FIG. 13 is a cross-sectional view showing an operation of the wireless power transfer apparatus according to Embodiment 3 for obtaining the maximum power transfer efficiency by movements of power transmission coils.

FIG. 14 is a cross-sectional view showing the arrangement in a wireless power transfer apparatus according to Embodiment 4 for explaining variations in the power transfer efficiency in response to the displacement between the central axis of the power transmission coil and the central axis of the power receiving coil.

FIG. 15 is a graph showing the relationship between the power transfer efficiency and the central axis displacement obtained by experiment based on the arrangement shown in FIG. 14.

FIG. 16 is a drawing showing an area in which the power transfer efficiency of the wireless power transfer apparatus according to Embodiment 4 is about 80% based on the relationship between the power transfer efficiency and the central axis displacement shown in FIG. 15.

FIG. 17 is a drawing for explaining the actions of the wireless power transfer apparatus according to Embodiment 4 when the central axis of the power receiving coil 3 is in an area A.

FIG. 18 is a drawing for explaining the actions of the wireless power transfer apparatus according to Embodiment 4 when the central axis of the power receiving coil 3 is in an area C′

FIG. 19 is a drawing for explaining the actions of the wireless power transfer apparatus according to Embodiment 4 when the central axis of the power receiving coil 3 is in an area D′

FIG. 20 is a drawing for explaining the actions of the wireless power transfer apparatus according to Embodiment 4 when the central axis of the power receiving coil 3 is in an area B′

FIG. 21 is a plan view showing an example in which power transmission coils forming first and second power transmission units of a wireless power transfer apparatus according to Embodiment 5 are arranged in a matrix.

FIG. 22 is a plan view showing an example in which the power transmission coils are close-packed.

FIG. 23 is a plan view showing an exemplary optimum arrangement of the power transmission coils for a configuration with reduced power transfer efficiency.

FIG. 24 is a cross-sectional view showing the configuration of a magnetic field resonance-type wireless power transfer apparatus according to Embodiment 6.

FIG. 25 is a cross-sectional view showing the configuration of a magnetic field resonance-type wireless power transfer apparatus according to Embodiment 8.

FIGS. 26A and 26B are plan views each showing an exemplary arrangement of power transmission coils of a conventional wireless power transfer apparatus.

FIGS. 27A and 27B are plan views each showing an exemplary arrangement of a power receiving coil corresponding to the same conventional wireless power transfer apparatus.

FIG. 28 is a cross-sectional view taken along the line A-A in FIG. 27B.

### DETAILED DESCRIPTION OF THE INVENTION

The wireless power transfer apparatus of the present invention, having the basic structure as described above, can be modified as follows.

That is, the wireless power transfer apparatus of the present invention can be configured such that the power transmission coil can be arranged so as to take a power transmission arrangement for transferring power to the placed power receiver, the housing has an interlock function to maintain the power transmission arrangement, and the interlock function maintains the surroundings of the power transmission coil and the power receiving coil to be electromagnetically shielded during power transfer.

Furthermore, the wireless power transfer apparatus of the present invention can further include: a first power transmission unit in which one or more of the power transmission coils are arranged in the same plane so as not to overlap one another; a second power transmission unit in which one or more of the power transmission coils are arranged in the same plane so as not to overlap one another; wherein the first power transmission unit and the second power transmission unit oppose each other to form a power receiving space therebetween in which the power receiver can be placed, the housing is configured to hold the first power transmission unit and the second power transmission unit, so that the power receiver can be placed in the power receiving space, the central axis of the one or more power transmission coils included in the first power transmission unit and the central axis of the one or more power transmission coils included in the second power transmission unit are displaced from each other, and the electromagnetic shield encompasses the surroundings of the first power transmission unit, the second power transmission unit, and the power receiving coil when at least one of the first power transmission unit and the second power transmission unit transfers power to the power receiving coil.

With this configuration, the first power transmission unit and the second power transmission unit are placed above and below the power receiving space in which the power receiver is placed, so that power can be transferred from above and below the power receiver. This reduces an area in which transmission is difficult due to the presence of a dead point, or suppresses a decrease in the transmission distance limited by the sizes of power transmission and power receiving coils. Consequently, it is possible to stably carry out power transfer in a wide range and to have a high degree of flexibility in placing the power receiver.

Furthermore, the wireless power transfer apparatus of the present invention can include a controller for controlling power transfer from the power transmission coil, wherein the controller controls the power transmission coil included in at least one of the first power transmission unit and the second power transmission unit to transfer power to the power receiving coil with the power receiver being placed in the power receiving space.

For example, when the power receiving coil of the power receiver is located substantially at the midpoint between the first transmission unit and the second transmission unit and the central axis of the power receiving coil and the central axis of the power transmission coil of the first or second power transmission unit are close to each other, power is transferred only from one power transmission coil nearest to the central axis. This allows an improvement in the power transfer efficiency and simplification of the apparatus, so that the cost of the power transfer apparatus can be reduced.

Furthermore, the wireless power transfer apparatus of the present invention can include a controller for controlling power transfer by the power transmission coil, wherein the controller has a function to control a plurality of any power transmission coils arranged in at least one of the first power transmission unit and the second power transmission unit to transfer power at the same time.

For example, when the central axis of the power receiving coil of the power receiving unit is displaced from the central axis of the power transmission coil of the first or second power transmission unit by half or more of the radius of the power transmission coil, power is transferred simultaneously from two given power transmission coils in the same plane nearest to the central axis of the power receiving coil transfer power. By transferring power simultaneously from a plurality of power transmission coils, the possible power transmission distance and plane range on one side increase, so that power can be transferred stably in a wide range. Thus, it is possible to have a high degree of flexibility in placing the power receiver.

Furthermore, the wireless power transfer apparatus of the present invention can further include a monitoring portion for detecting the position of the power receiving coil, wherein the controller controls the power transmission coil selected in accordance with the detected position of the power receiving coil to transfer power.

Furthermore, the wireless power transfer apparatus of the present invention can be configured such that the power transmission coil included in the first power transmission unit and the power transmission coil included in the second power transmission unit have the same diameter, and the maximum displacement between the central axis of the power transmission coil included in the first power transmission coil and the central axis of the power transmission coil included in the second power transmission unit is equal to the diameter of each power transmission coil.

Hereinafter, Embodiments of the present invention will be described with reference to the drawings.

### Embodiment 1

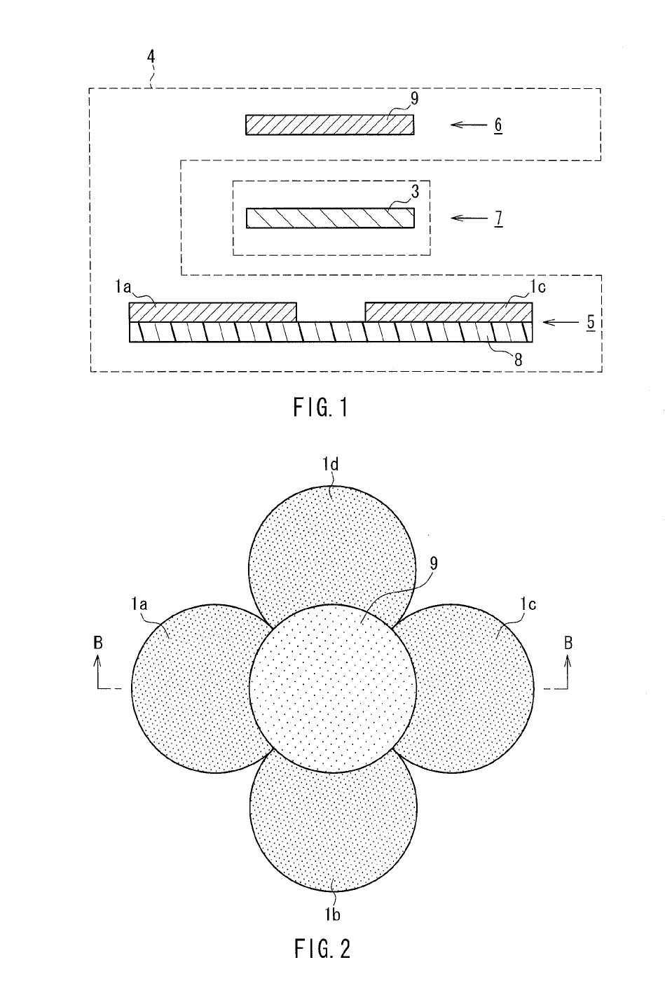

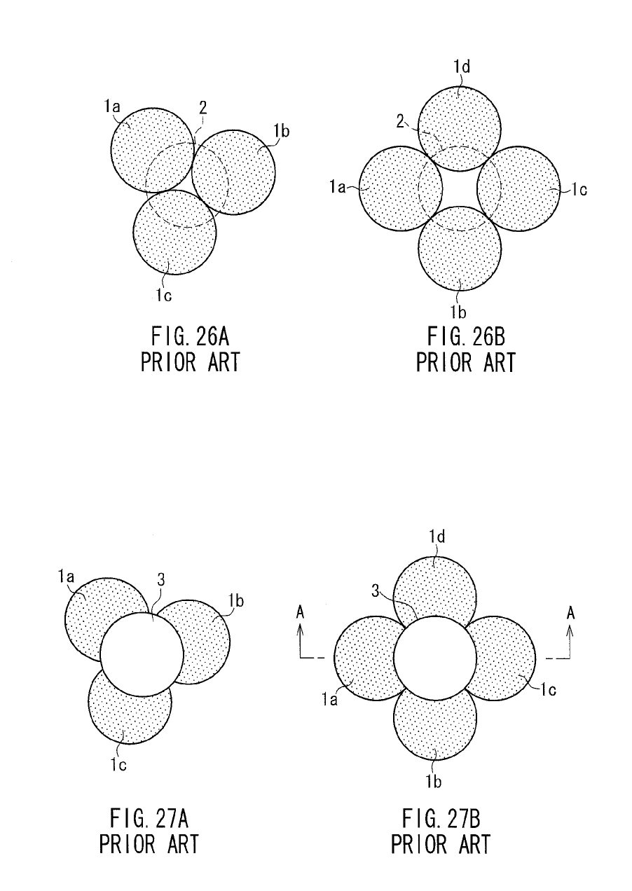

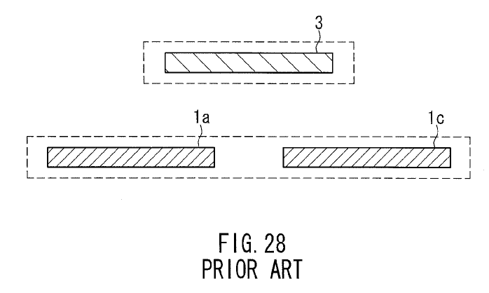

FIG. 1 is a cross-sectional view showing the configuration of a magnetic field resonance-type wireless power transfer apparatus according to Embodiment 1, and FIG. 2 is a plan view showing the configuration of the apparatus. FIG. 1 shows a cross section taken along the line B-B in FIG. 2. Note that the same components as those of the conventional wireless power transfer apparatus shown in FIGS. 26 to 28 are denoted by the same reference numerals and their description will not be repeated.

The wireless power transfer apparatus (power transmission apparatus) 4 according to this embodiment includes a first power transmission unit 5 disposed on the lower side and a second power transmission unit 6 disposed on the upper side of the apparatus. When the first power transmission unit 5 and the second power transmission unit 6 are arranged so as to oppose each other as in FIG. 1, a power receiving space of a predetermined size is formed between the power transmission units. A power receiver 7 is placed in this power receiving space and power is transferred. The first power transmission unit 5 includes four power transmission coils 1a to 1d arranged on the substrate 8 so as not to overlap one another in the same plane. The second power transmission unit 6 includes one power transmission coil 9 (the substrate is not illustrated).

The power transmission coils 1a to 1d and 9 each include a resonance coil (not illustrated) for causing magnetic field resonance. The power transmission coils 1a to 1d are arranged on the substrate 8 such that their resonance coils are oriented parallel to each other axially. Noted that the substrate 8 will not be illustrated in the drawings referenced hereafter. The first power transmission unit 5 and the second power transmission unit 6 are arranged such that their resonance coils are oriented parallel to each other axially.

In FIG. 1, the first power transmission unit 5 and the second power transmission unit 6 are shown in an arrangement for transferring power (power transfer arrangement). The power receiver 7 is provided with one power receiving coil 3 including a resonance coil. In this power transfer arrangement, power can be transferred through magnetic field resonance between the resonance coils of the first power transmission unit 5 and the second power transmission unit 6 and the resonance coil of the power receiving coil 3. The power receiver 7 also includes a substrate but the substrate is not illustrated in the drawing. The first power transmission unit 5 and the second power transmission unit 6 may be fixed to the power transfer arrangement or may be configured to have other arrangement by which no power receiving space is formed (described later).

Further, as will be explained later, the second power transmission unit 6 can include a plurality of power transmission coils 9. Also in this case, the power transmission coils 9 of the second power transmission unit 6 are arranged so as not to overlap one another in the same plane and the resonance coils are oriented parallel to each other axially.

The adoption of the power transfer arrangement in which the first power transmission unit 5 is arranged on the lower side and the second power transmission unit 6 is arranged on the upper side as in this embodiment allows optimum power transmission/reception in a wide range, as will be described later.

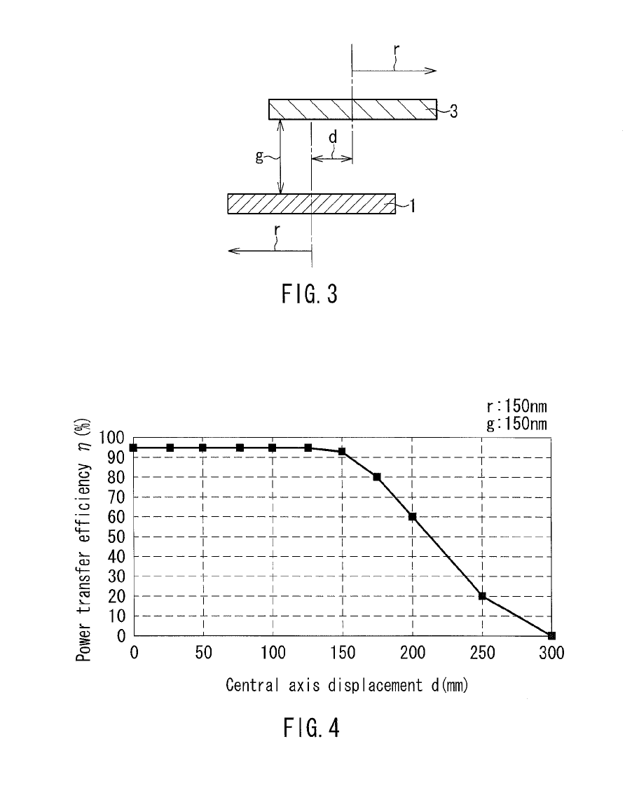

First, experimental results on variations in the power transfer efficiency in response to a displacement between the central axis of a power transmission coil and the central axis of a power receiving coil will be explained. As shown in FIG. 3, the radius r1 of the power transmission coil 1 and the radius r2 of the power receiving coil 3 are set so as to satisfy r1=r2=r, (it is easier to bring the resonance conditions into agreement if the power transmission coil 1 and the power receiving coil 3 have the same radius). “g” denotes the distance between the power transmission coil 1 and the power receiving coil 3 (the spacing in the axial direction), and “d” denotes the displacement between the central axis of the power transmission coil 1 and the central axis of the power receiving coil 3. In the experiment, “r” was fixed to 150 mm, and “g” was fixed to 150 mm, and the central axis displacement “d” was varied. Helical antennas of 5 turns (5 mm pitch) were used for the resonance coils of the power transmission coil 1 and the power receiving coil 3.

FIG. 4 shows the relationship between the power transfer efficiency η and the central axis displacement d, which was obtained as a result of the experiment. As can be seen from the graph, the power transfer efficiency η remained unchanged (about 95%) when the displacement “d” was up to about 150 mm but the power transfer efficiency η decreased as the displacement “d” became larger than about 150 mm.

As can be understood from these results, power can be transferred at the maximum level without any problem unless the displacement between the central axis of the power transmission coil 1 and the central axis of the power receiving coil 3 is within the radius “r” of each coil. Such a relationship remains substantially unchanged even if the power transmission coil 1 and the power transmission coil 3 are changed to have a different radius from the radius “r”. Furthermore, this tendency is not limited to the helical antennas and it remains substantially unchanged even if flat coils (e.g., thin-film coils) are used.

On the other hand, the power transfer efficiency in the electromagnetic induction type drops to almost 0 if the central axis of the power transmission coil 1 is displaced from the central axis of the power receiving coil 3 by half the size of the coil. This shows that the magnetic field resonance type is superior over the electromagnetic induction type in terms of displacement.

A weakening of the coupling is considered to be the cause of the decrease in the power transfer efficiency resulting from the displacement because the coupling itself is weakened as the center-to-center distance between the power transmission coil 1 and the power receiving coil 3 increases. The power transmission coil 1 and the power receiving coil 3 had the same radius in the explanations given above, but similar results were obtained even when they had different radiuses. In that case, however, it is necessary to match the resonance conditions. Further, the radius “r” that determines the range of the displacement “d” is the radius r1 of the power transmission coil 1.

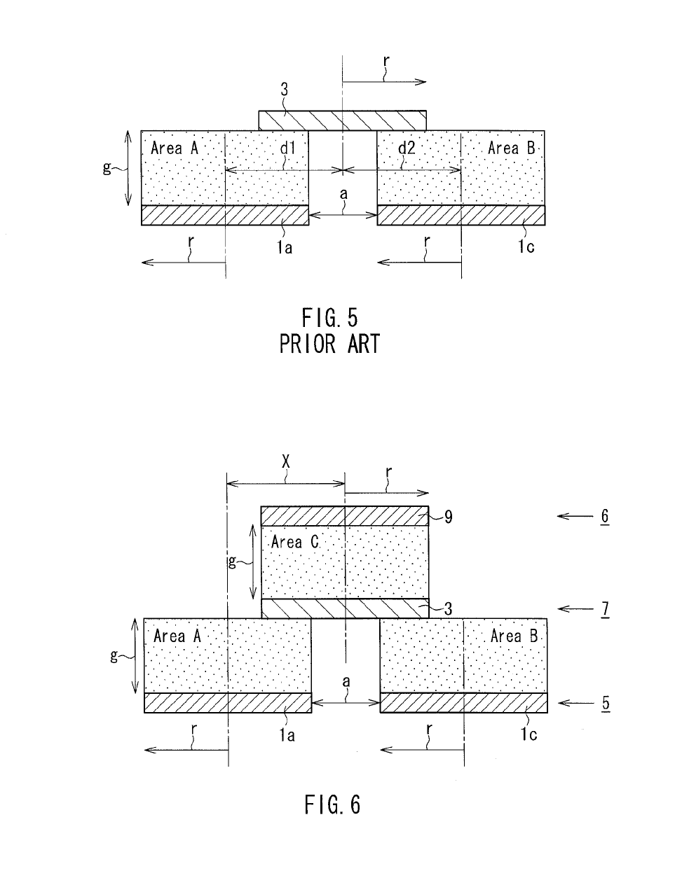

For example, when the power receiving coil 3 is located at the center of the dead point area in the arrangement of the four power transmission coils 1 of the power transmission unit as shown in FIG. 27B, the displacement “d” between the central axis of each power transmission coil 1 and the central axis of the power receiving coil 3 can be expressed as 2^{1/2}r. Thus, based on the relationship shown in FIG. 4, the power transfer efficiency is quite likely to deteriorate. To make this easier to understand, FIG. 5 shows the cross-sectional view taken along the line A-A in FIG. 27B, in which the actions of the power transmission coils 1 are represented graphically. In FIG. 5, the displacement “d” between the central axis of each power transmission coil 1 and the central axis of the power receiving coil 3 is larger than the radius “r” of each coil. The power transmission coils 1a and 1c are apart from each other by the distance a. “d1” denotes the displacement between the central axis of the power transmission coil 1a and the central axis of the power receiving coil 3, and “d2” denotes the displacement between the central axis of the power transmission coil 1c and the central axis of the power receiving coil 3.

Areas A and B are schematic representations of areas in which power transfer at the maximum efficiency is possible. In the area A, the maximum power transfer efficiency can be obtained when the central axis displacement “d1” is within the radius “r”. It should be noted that the maximum power transfer efficiency refers to power transfer efficiency defined as a value in a practically sufficient range. In the area B, the maximum power transfer efficiency can be obtained when the central axis displacement “d2” is within the radius “r”. As can be seen from the drawing, the power transfer efficiency decreases when the central axis of the power receiving coil 3 is located in the area within the distance “a” between the power transmission coils 1a and 1c. The power transfer efficiency is considered to become the lowest when the central axis of the power receiving coil 3 is located at the midpoint of the center-to-center distance between the power transmission coils 1a and 1c (d1=d2).

In this embodiment, the power transmission coil 9, which is included in the second power transmission unit 6 and has the radius “r”, is arranged on the opposite side to the power transfer coil 1a interposing the power receiving coil 3 as shown in FIG. 1, so as to prevent the decrease in the power transfer efficiency resulting from the influence of the dead point. FIG. 6 shows the positional relationship between the coils. “d3” denotes the displacement between the central axis of the power transmission coil 9 and the central axis of the power receiving coil 3 (“d3” is not shown in FIG. 6 because “d3” is equal to 0). As shown in FIG. 6, the distance between the power transmission coil 9 and the power receiving coil 3 in the transmission direction (vertical direction) is, for example, the same as the distance “g” between the power transmission coil 1a and the power receiving coil 3. The presence of the power transmission coil 9 adds an area C in which the maximum power transfer efficiency can be obtained when the central axis displacement “d3” is within the radius “r”.

The extent of the areas covered by this configuration becomes the largest when the central axis of the power transmission coil 9 is located at the midpoint of the center-to-center distance between the power transmission coils 1a and 1c. That is, X as a preferred displacement between the central axis of the power transmission coil 1a and the central axis of the power transmission coil 9 can be expressed as (2r+a)/2, where (2r+a) represents the distance between the central axis of the power transmission coil 1a and the central axis of the power transmission coil 9. Here, the maximum displacement Xmax, which gives the largest possible power receiving area in the plane direction, can be obtained when a is equal to 2r (i.e., the diameter of the power transmission coil 9). For this reason, Xmax is equal to 2r. A range “Z” in which power can be received optimally in the plane direction at the position of the power receiving coil 3 can be expressed as (4r+a). Since the largest possible power receiving range Zmax can be obtained when a is equal to 2r, Zmax is equal to 6r.

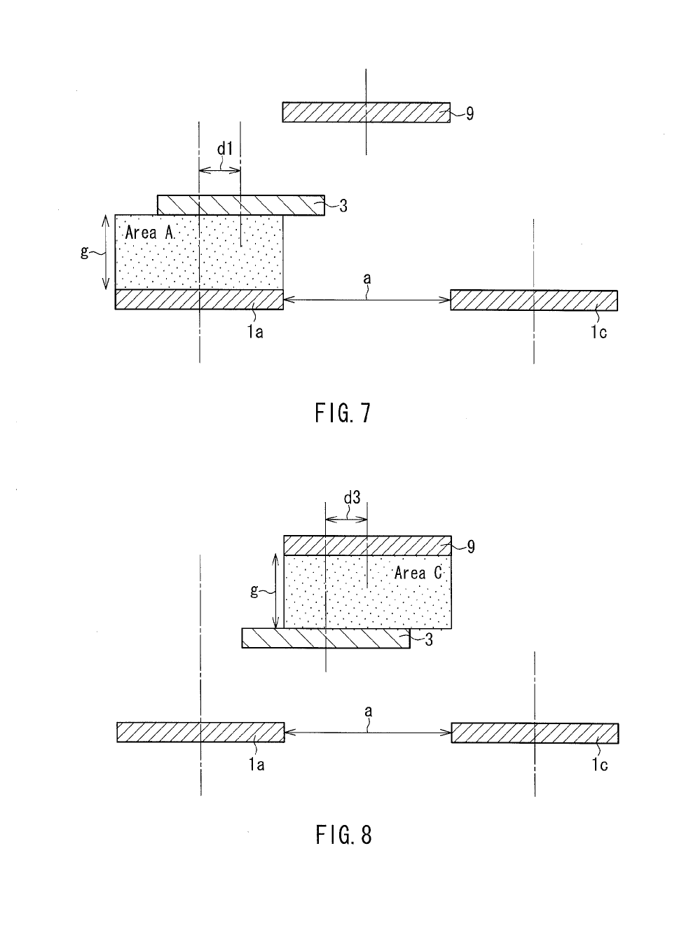

The arrangement of the power transmission coils 1a to 1d and 9 as shown in FIG. 6 allows optimum power transmission/reception in a wide range. Practically, however, it may not be preferable to transfer power from all of the power transmission coils to one power receiving coil at the same time in terms of the efficiency. For this reason, it is desirable that one of the power transmission coils for actually transferring power is selected in accordance with the area in which the central axis of the power receiving coil 3 is located. This will be described with reference to FIGS. 7 to 9. For the sake of easy understanding, the explanation is directed to a case where the maximum displacement Xmax that gives the largest possible power receiving area in the plane direction is 2r (a=2r).

FIGS. 7 to 9 show power transfer when the horizontal position of the power receiving coil 3 is in the areas A, C, and B, respectively. In FIG. 7, the displacement “d1” between the central axis of the power transmission coil 1a and the central axis of the power receiving coil 3 is within the radius “r”. In this case, since the maximum power transfer efficiency can be obtained in the area A, power may be transferred to the power receiving coil 3 only by using the power transmission coil 1a.

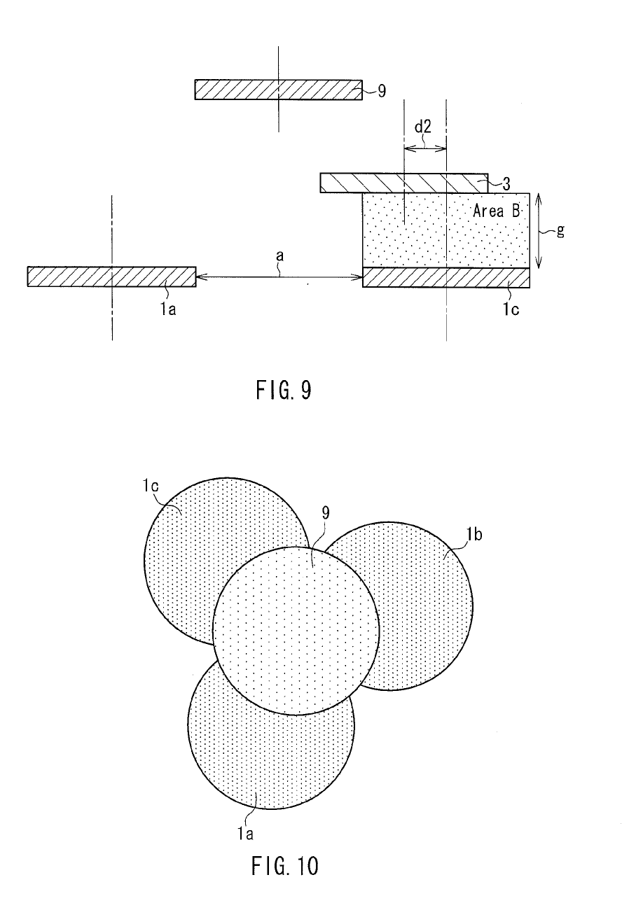

Similarly, as shown in FIG. 8, when the displacement “d3” between the central axis of the power transmission coil 9 and the central axis of the power receiving coil 3 is within the radius “r”, the maximum power transfer efficiency can be obtained in the area C. Thus, in this case, power transfer to the power receiving coil 3 may be performed only by the power transmission coil 9. Furthermore, as shown in FIG. 9, when the displacement “d2” between the central axis of the power transmission coil 1c and the central axis of the power receiving coil 3 is within the radius “r”, the maximum power transfer efficiency can be obtained in the area B. Thus, in this case, power transfer to the power receiving coil 3 may be performed only by the power transmission coil 1c.

In order to perform power transfer by selecting one of the power transmission coils 1a to 1d and 9, the wireless power transfer apparatus is provided with a controller for selecting one of the power transmission coils 1a to 1d and 9, and, for example, a monitoring portion for detecting the position of the power receiving coil 3 (both of which are not illustrated). And the controller controls to transmit an electric power from the power transmission coil selected in accordance with the detected position of the power receiving coil 3. For example, the monitoring portion can be configured to apply a laser beam to the power receiver 7 to detect the position and posture of the power receiver 7 based on the reflected light. Because the position of the power receiving coil 3 in the power receiver 7 is specified, it is possible to detect the position of the power receiving coil 3. Or, it is also possible to detect the position of the power receiver 7 by imaging the power receiver 7 with an image pickup device and conducting pattern recognition.

As described above, the wireless power transfer apparatus according to this embodiment includes, in addition to the conventional first power transmission unit 5 including the power transmission coils 1a and 1c, the second power transmission unit 6 including the power transmission coil 9 in contemplation of such a case as the power receiving coil 3 being located near the center of the possible dead point area. The second power transmission unit 6 and the first power transmission unit 5 are arranged substantially parallel to each other and to oppose each other such that the central axis of each power transmission coil 1 of the first power transmission unit 5 and the central axis of the power transmission coil 9 of the second power transmission unit 6 are displaced appropriately from each other. The power receiver 7 including the power receiving coil 3 is placed between the first power transmission unit 5 and the second power transmission unit 6, and power is transferred wirelessly to the power receiving coil 3 from the power transmission coil of at least one of the first power transmission unit 5 and the second power transmission unit 6.

FIG. 10 shows an exemplary optimum arrangement of the power transmission coil 9 provided in the second power transmission unit 6 where a plan configuration is different from that shown in FIG. 2 and three power transmission coils 1a to 1c are disposed so as to be in contact with each other in the power transmission unit 5. More specifically, the central axis of the power transmission coil 9 is preferably located around the center of the possible dead point area. In this case, when the radius of each coil is “r”, the displacement between the central axes of the power transmission coil 1a on the first power transmission unit side and the power transmission coil 9 on the second power transmission unit side is (2×3^{1/2}/3) r.

### Embodiment 2

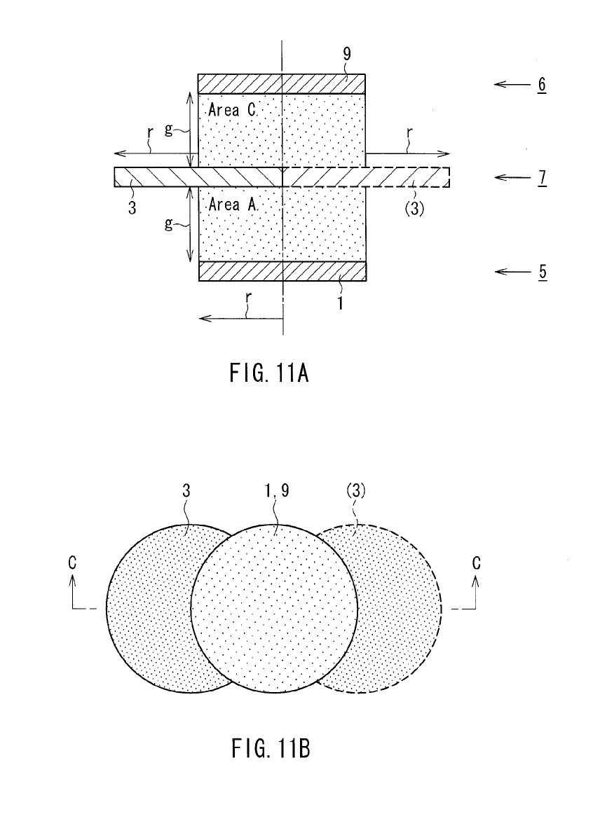

FIG. 11A is a cross-sectional view showing the configuration of a magnetic field resonance-type wireless power transfer apparatus according to Embodiment 2, and FIG. 11B is a plan view showing the configuration of the apparatus. FIG. 11A shows a cross section taken along the line C-C in FIG. 11B.

This embodiment is directed to an exemplary arrangement of power transmission coils, which is intended to increase the possible power receiving area in the power transmission direction (the axial direction of each power transmission coil). In the exemplary arrangement shown in FIGS. 11A and 11B, the first power transmission unit 5 includes one power transmission coil 1, the second power transmission unit 6 includes one power transmission coil 9, and the central axes of the power transmission coil 1 and the power transmission coil 9 substantially coincide with each other. The first power transmission unit 5 and the second power transmission unit 6 are arranged so as to oppose each other to form a power receiving space of a predetermined size, and their resonance coils are oriented parallel to each other axially. The power receiving coil 3 of the power receiver 7 is disposed in the power receiving space between the first and second power transmission units 5, 6. In the drawings, the power receiving coil 3 indicated by a solid line is at the position where its central axis is displaced toward the left side from the central axis of each of the power transmission coils 1 and 9 by the distance “r”. On the other hand, the power receiving coil (3) indicated by a dotted line is at the position where its central axis is displaced toward the right side from the central axis of each of the power transmission coils 1 and 9 by the distance “r”.

In the arrangement shown in FIG. 11A, power can be transferred favorably in the combined areas A and C. That is, the power transmission coil 1 gives the maximum power transfer efficiency in the area A where the displacement between the central axis of the power transmission coil 1 and the central axis of the power receiving coil 3 is within the radius “r”. The power transmission coil 9 gives the maximum power transfer efficiency in the area C where the displacement between the central axes of the power transmission coil 9 and the power receiving coil 3 is within the radius “r”.

More specifically, while the maximum power transfer efficiency can be obtained only in the area A in the conventional example with one power transmission coil 1, the possible power receiving area up to twice as large as that in the conventional example can be obtained in the power transmission direction. At this time, a possible power receiving range Zmax, which is optimal in the plane, corresponds to the center-to-center distance between the power receiving coil 3 and the power receiving coil (3), which is equal to 2r as in the conventional example.

As shown in this embodiment, by leaving a space between any power transmission coil formed in the first power transmission unit and any power transmission coil formed in the second power transmission unit at interval of the total of the respective distances capable of obtaining the maximum transmission efficiency for the both power transmission coils, while opposing each other with their central axes being substantially coincided, the possible power receiving area in the power transfer direction can be increased as a result.

### Embodiment 3

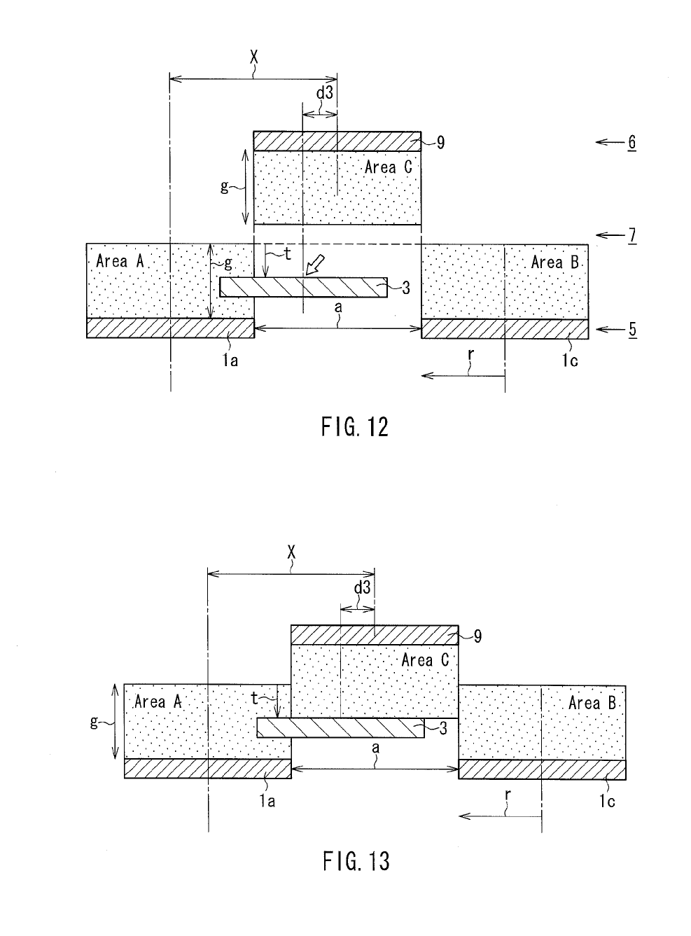

A magnetic field resonance-type wireless power transfer apparatus according to Embodiment 3 will be described with reference to FIG. 12. In this embodiment, the power transmission coils are arranged in the same manner as the power transmission coils 1a to 1d and 9 in Embodiment 1 shown in FIG. 6. In FIG. 12, however, the power receiving coil 3 is disposed outside the possible power receiving area. In this case, although the displacement “d3” between the central axis of the power receiving coil 3 and the central axis of the power transmission coil 9 is within the radius “r”, the transfer efficiency decreases because the power receiving coil 3 is far away in the power transmission direction from the area C, in which the maximum power transfer efficiency can be obtained.

Thus, in this embodiment, the position of the power receiving coil 3 is monitored, and the power transmission coils 1a, 1c and 9 are moved to align the midpoint (distance “g”) between the plane position of the power transmission coils 1a and 1c and the plane position of the power transmission coil 9 with the center of the power receiving coil 3.

As the case may be, the power transmission coil 9 may be moved alone by the distance t in the transmission direction as shown in FIG. 13 so that power can be transferred to the power receiving coil 3 at the maximum efficiency. In this way, it is possible to transfer power with certainty by moving the positions of the power transmission coils appropriately in accordance with the position of the power receiving coil.

### Embodiment 4

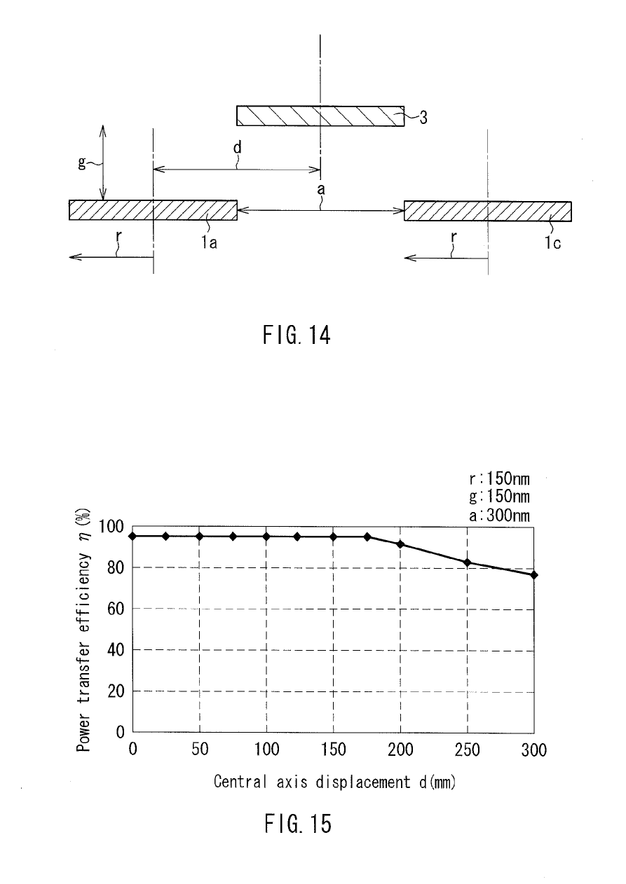

A magnetic field resonance-type wireless power transfer apparatus according to Embodiment 4 will be described with reference to FIGS. 14 to 20. This embodiment provides a solution to the deviation of the power receiving coil from the area with the maximum power transfer efficiency, which is different from moving the positions of the power transmission coils as in Embodiment 3. That is, in each of the embodiments described above, power is basically transferred to the power receiving coil from one power transmission coil. In this embodiment, on the other hand, any two power transmission coils arranged in the same plane are controlled to transfer power at the same time.

First, in connection with the configuration of this embodiment, experimental results on variations in the power transfer efficiency according to a displacement between the central axis of a power transmission coil and the central axis of a power receiving coil will be explained. As shown in FIG. 14, the experiment was carried out by measuring variations in the power transfer efficiency according to the displacement “d” between the central axes of the power transmission coil 1a and the power receiving coil 3 during simultaneous power transfer from the power transmission coils 1a and 1c. In the experiment, the distance “a” between the two power transmission coils 1a and 1c was fixed to 2r (the diameter of the power receiving coil 3) with which the power transfer efficiency seems to be the smallest.

Here, “r” denotes the radius of each of the power transmission coils 1a and 1c and the power receiving coil 3, “g” denotes the distance between the power transmission coil 1a and the power receiving coil 3 in the transmission direction, and “d” denotes the displacement between the central axis of the power transmission coil 1a and the central axis of the power receiving coil 3. In the experiment, “r” was fixed to 150 mm, “g” was fixed to 150 mm, and a was fixed to 300 mm, and the central axis displacement “d” was varied. FIG. 15 shows the relationship between the power transfer efficiency η and the central axis displacement d, which was obtained as a result of the experiment. As can be seen from the graph, the power transfer efficiency η remained unchanged (about 95%) when the displacement “d” was up to about 150 mm (=r) but the power transfer efficiency η decreased as the displacement “d” became larger than about 150 mm.

As can be seen from these results, the maximum power transfer efficiency can be obtained without any problem unless the displacement “d” between the central axis of the power transmission coil 1 and the central axis of the power transmission coil 3 is within the coil radius “r”. Furthermore, it has been found that a decrease in the power transfer efficiency is small, i.e., about 20%, even when the central axis displacement “d” is twice as large as the radius, i.e., “d” is equal to the diameter of the power receiving coil 3 (2r=300 mm). Such a relationship remains substantially unchanged even when the power transmission coils and the power receiving coil have different radiuses. According to this, it is possible to increase the possible power receiving area in the power transmission direction when there is an enough margin for the transmission power with the reduced power transfer efficiency of about 80%.

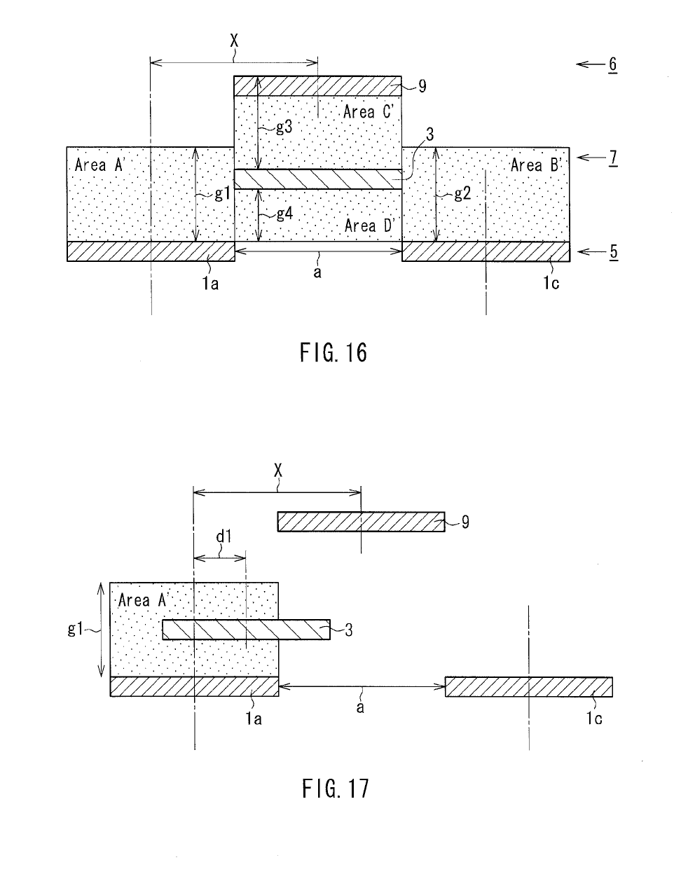

FIG. 16 shows areas in which the power transfer efficiency is about 80%. In an area A′ in which the power transfer efficiency of 80% can be obtained by the power transmission coil 1a when the displacement between the central axis of the power transmission coil 1a and the central axis of the power receiving coil 3 is within the radius “r”, a power transmission distance “g1” in the power transmission direction is larger than the power transmission distance “g” in the power transmission direction shown in FIG. 6. Similarly, in an area B′ in which the power transfer efficiency of 80% can be obtained by the power transmission coil 1c when the displacement between the central axis of the power transmission coil 1c and the central axis of the power receiving coil 3 is within the radius “r”, a power transmission distance “g2” in the power transmission direction is larger than the power transmission distance “g” in the power transmission direction shown in FIG. 6. Further, in an area C′ in which the power transfer efficiency of 80% can be obtained by the power transmission coil 3 when the displacement between the central axis of the power transmission coil 9 and the central axis of the power receiving coil 3 is within the radius “r”, a power transmission distance “g3” in the power transmission direction is larger than the power transmission distance “g” in the power transmission direction shown in FIG. 6. That is, g1=g2=g3>g.

While the areas A′, B′ and C′ correspond to the power transfer efficiency of 80% when power is transferred from one power transmission coil, an area D′ shown in FIG. 16 indicates area where the power transfer efficiency of 80% can be obtained when power is transferred from the power transmission coils 1a and 1c at the same time. Consequently, the maximum power transmission distance in the power transmission direction in the combined area C′ of the power transmission coil 9 and the area D′ becomes (g3+g4) which is larger than that in the conventional example.

FIGS. 17 to 20 show ways of power transfer in the respective areas where the maximum displacement Xmax for the largest possible power receiving area in the plane direction is 2r (a=2r). In FIG. 17, the central axis of the power receiving coil 3 is distant from the central axis of the power transmission coil 1a within the radius “r”. That is, the displacement “d1” between the central axis of the power transmission coil 1a and the central axis of the power receiving coil 3 is within the radius “r”. Further, the spacing between the power receiving coil 3 and the power transmission coil 1a is within “g1”. That is, since the power receiving coil 3 is located in the area A′ in which the maximum power transfer efficiency can be obtained by the power transmission coil 1a, power may be transferred to the power receiving coil 3 only from the power transmission coil 1a.

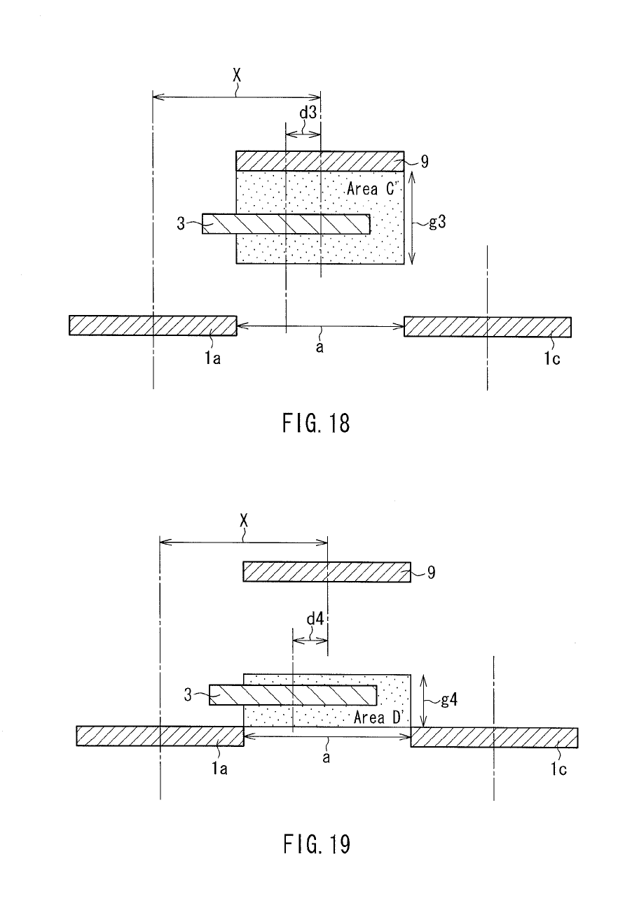

Similarly, in FIG. 18, the displacement “d3” between the central axis of the power transmission coil 9 and the central axis of the power receiving coil 3 is within the radius “r”, and the spacing between the power receiving coil 3 and the power transmission coil 9 in the power transmission direction is within “g3”. In this case, since the power receiving coil 3 is located in the area C′ in which the maximum power transfer efficiency can be obtained by the power transmission coil 9, power may be transferred to the power receiving coil 3 only from the power transmission coil 9.

Furthermore, in FIG. 19, the displacement “d4” between the central axis of the power transmission coil 9 and the central axis of the power receiving coil 3 is within the radius “r”, and the spacing between the power receiving coil 3 and the power transmission coil 1a in the power transmission direction is within “g4”. In this case, since the power receiving coil 3 is located in the area D′ in which the maximum power transfer efficiency can be obtained by the power transmission coils 1a and 1c, power may be transferred to the power receiving coil 3 from the power transmission coils 1a and 1c at the same time.

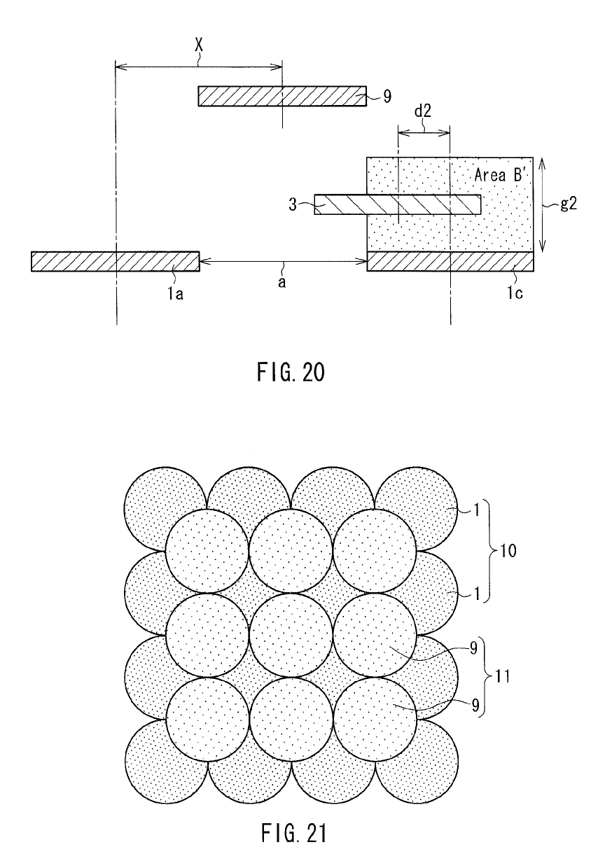

Further, in FIG. 20, the displacement “d2” between the central axis of the power transmission coil 1c and the central axis of the power receiving coil 3 is within the radius “r”, and the spacing between the power receiving coil 3 and the power transmission coil 1c in the power transmission direction is within “g2”. In this case, since the power receiving coil 3 is located in the area B′ in which the maximum power transfer efficiency can be obtained by the power transmission coil 1c, power may be transferred to the power receiving coil 3 only from the power transmission coil 1c.

As described above, the wireless power transfer apparatus according to this embodiment includes, similarly to Embodiment 1, the first power transmission unit including the power transmission coils as in the conventional example and the second power transmission unit including an additional power transmission coil. In order to increase the area in which power can be transferred optimally, the second power transmission unit and the first power transmission unit are arranged substantially parallel to each other and to oppose each other such that the central axis of each power transmission coil 1 of the first power transmission unit and the central axis of the power transmission coil of the second power transmission unit are displaced appropriately from each other. The power reception unit is placed in the power receiving space between the first and second power transmission units, one power transmission coil of at least one of the first and second power transmission units is operated or two transmission coils of at least one of the first and second power transmission units are operated at the same time for transferring power in accordance with the position of the power receiving coil. Depending on the arrangement of the power transmission coils, power may be transferred simultaneously from three or more power transmission coils disposed in the same plane.

### Embodiment 5

FIG. 21 is a plan view showing the configuration of a magnetic field resonance-type wireless power transfer apparatus according to Embodiment 5. In this embodiment, the power transmission coils 1 included in a first power transmission unit 10 are arranged in a matrix of 4×4, and a plurality of power transmission coils 9 included in a second power transmission unit 11 are arranged to oppose the power transmission coils 1.

As can be seen from the drawing, the number of the power transmission coils 1 of the first power transmission unit 10 is 16 but the number of the power transmission coils 9 of the second power transmission unit 11 is 9, which is smaller than the number of the power transmission coils 1. That is, since the center of each power transmission coil 9 of the second power transmission unit 11 is aligned with each position to be a dead point in the arrangement of the power transmission coils 1 of the first power transmission unit 10, the number of the power transmission coils 9 of the second power transmission unit 11 can be reduced. When the radius of each of the power transmission coils 1 and 9 is “r”, the smallest center-to-center distance between two adjacent power transmission coils in the same plane in the first power transmission unit 10 and the second power transmission unit 11 is 2r, and the smallest displacement between the central axis of each power transmission coil 1 and the central axis of each power transmission coil 9 is 2^{1/2}r.

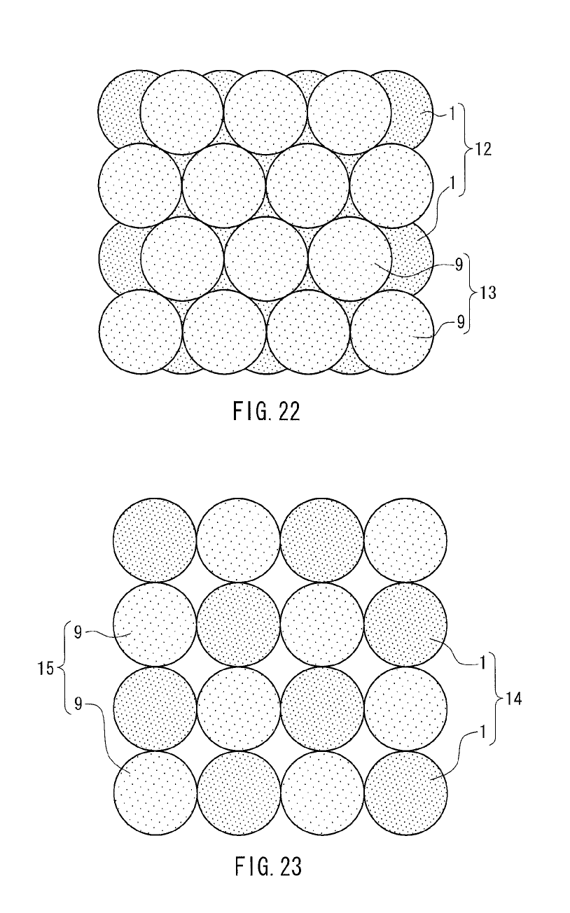

FIG. 22 shows an exemplary arrangement in which the power transmission coils 1 included in a first power transmission units 12 are closest packed in 4×4. As can be seen from this drawing, the number of the power transmission coils 9 is equal to the number of the power transmission coils 1 when the center of each power transmission coil 9 of the second power transmission unit 13 is aligned with each position to be a dead point in the arrangement of the power transmission coils 1 of the power transmission unit 12. Here, when the radius of each of the power transmission coils 1 and 9 is “r”, the smallest center-to-center distance between two adjacent power transmission coils in the same plane in the first power transmission unit 12 and the second power transmission unit 13 is 2r, and the smallest displacement between the central axis of each power transmission coil 1 and the central of each power transmission coil 9 is “r”. However, this arrangement results in a somewhat smaller optimum possible power receiving range in the plane direction and an increase in the total number of the power transmission coils included in the first power transmission unit 12 and the second power transmission unit 13 in comparison to the matrix arrangement shown in FIG. 21. Thus, it is preferable to arrange the power transmission coils included in the first power transmission unit 10 and the second power transmission unit 11 in a matrix of 4×4 as shown in FIG. 21.

FIG. 23 shows an exemplary arrangement employed when power is transferred simultaneously from two given power transmission coils as explained in Embodiment 4. In a first power transmission unit 14, eight power transmission coils 1 are arranged evenly and are spaced by the diameter (2r). Also in a second power transmission unit 15, eight power transmission coils 9 are arranged evenly and are spaced by the diameter (2r). The first power transmission unit 14 and the second power transmission unit 15 are arranged so as to oppose each other such that the central axis of each power transmission coil in the first power transmission unit 14 and the central axis of each power transmission coil in the second power transmission unit 15 are displaced by 2r. In this case, the power transfer efficiency decreases but the total number of the power transmission coils in the first power transmission unit 14 and the second power transmission unit 15 can be significantly reduced to 16. As with the configuration of Embodiment 4 shown in FIG. 16, the power transmission coils 1 and 9 for transferring power are selected in accordance with the position of the power receiving coil.

### Embodiment 6

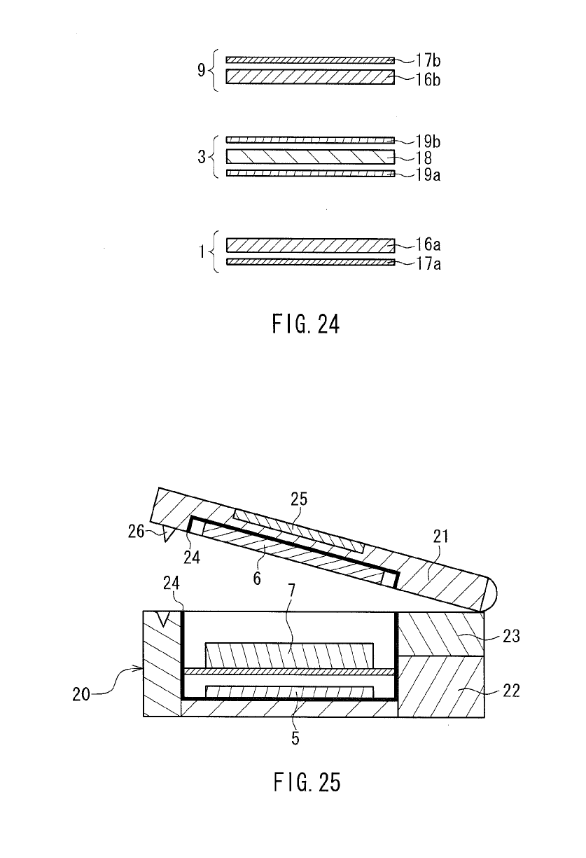

FIG. 24 is a cross-sectional view showing the configuration of a magnetic field resonance-type wireless power transfer apparatus according to Embodiment 6. In many cases, power transmission coils and power receiving coils generally have a resonance coil for transferring power and utilize a loop coil for supplying power received from a high-frequency power source to the resonance coil by electromagnetic induction, as described above. Also in this embodiment, the power transmission coils 1 and 9 and the power receiving coil 3 each include a resonance coil and a loop coil. By way of example, FIG. 24 schematically shows the positional relationship between resonance coils and loop coils forming the power transmission coil 1 of the power transmission unit 5, the power transmission coil 9 of the second power transmission unit 6, and the power receiving coil 3 of the power receiver 7 placed between the power transmission coils 1 and 9.

The power transmission coil 1 is composed of a resonance coil 16a and a loop coil 17a, and the power transmission coil 9 is composed of a resonance coil 16b and a loop coil 17b. The resonance coils 16a and 16b are each arranged to face inward. The feature of this embodiment is that the power receiving coil 3 is composed of a resonance coil 18 and loop coils 19a and 19b between which the resonance coil 18 is interposed.

First, when transferring power from the power transmission coil 1 to the power receiving coil 3, power supplied from a high-frequency power source is transferred from the loop coil 17a to the resonance coil 16a by electromagnetic induction. The electric power supplied to the resonance coil 16a is transferred by means of a resonance phenomenon to the resonance coil 18 of the power receiving coil 3 operating at the same resonance frequency as the resonance coil 16a. In the end, the power is transferred from the resonance coil 18 to the loop coil 19b to which a load is connected. Similarly, when transferring power from the power transmission coil 9 to the power receiving coil 3, power supplied from the high-frequency power source is transferred from the loop coil 17b to the resonance coil 16b by electromagnetic induction. And the electric power is transferred by means of a resonance phenomenon to the resonance coil 18 of the power receiving coil 3 operating at the same resonance frequency as the resonance coil 16b. In the end, the power is transferred from the resonance coil 18 to the loop coil 19a to which a load is connected.

In this embodiment, with respect to the loop coils 19a and 19b disposed on the both sides of the resonance coil 18, a control is performed, before the loop coils 19a and 19b receive the power, to select the loop coil on the appropriate side automatically to transfer the power to the target load in accordance with a detection which power transmission coil transfers power.

Or, power may actually be received by each of the loop coils 19a and 19b, and the loop coil that received larger power may be used. Further, power received by the loop coils 19a and 19b may be combined, and the combined power may be supplied to the load, if necessary. In these cases, it is desirable to match the impedances in view of the presence of the loop coils between the resonance coils of the power transmission coils and the resonance coil of the power receiving coil in advance.

The feature of this embodiment is that power can be received by the power receiving coil 3 from the both sides. In that case, if metal is present between the power transmission coils and the power receiving coil, the metal absorbs an electromagnetic field, thereby causing energy losses, i.e., causing a decrease in the power transfer efficiency. Thus, in this embodiment, metal that may affect power transmission is not disposed on the both sides of the power receiving coil.

Although in this embodiment, an example of using loop coils for supplying power from the high-frequency power supply is described, it is possible to apply the present invention to a configuration that does not use loop coils, such as autonomously matching a variety of parameters of introduction power and coils. It is also possible to integrate a loop coil and a resonance coil into a singe coil and to directly control the inductance of the coil.

### Embodiment 7

In a magnetic field resonance-type wireless power transfer apparatus according to this embodiment, the first power transmission unit, the second power transmission unit, and the power receiver can have the same configuration as that in any of the embodiments described above or can have other configurations embraced in the present invention. The feature of this embodiment is to include a control device for selecting an appropriate power transmission coil from a plurality of power transmission coils for transferring power in accordance with the position of a power receiving coil.

As a method of selecting a power transmission coil, the following control may be performed. For example, the control includes detecting the magnetic resistance of a resonance coil of each power transmission coil, and determining the power transmission coil having the resonance coil with the smallest magnetic resistance, thereby selecting the such power transmission coil. Thus, this method utilizes the characteristic that the magnetic resistance of the power transmission coil closer to the power receiving coil becomes lower. The specific procedures will be described with reference to FIGS. 1 and 2.

First, with the power receiver 7 being placed between the first power transmission unit 5 and the second power transmission unit 6, a magnetic resistance of each of the resonance coils included in the power transmission coils 1a to 1d of the first power transmission unit 5 is measured one by one. Next, a magnetic resistance of each of the resonance coils included in the power transmission coils 9 of the second power transmission unit 6 is measured one by one in the same manner (only one resonance coil in FIG. 1). Then, the values of magnetic resistance obtained are compared to each other to determine the power transmission coil having the resonance coil with the smallest value of magnetic resistance. In the end, in view of the position of the determined power transmission coil, an electric power is transferred from one power transmission coil or simultaneously from two power transmission coils in the same plane that are adjacent to each other, which are nearest to the power receiving coil 3.

Instead of measuring the resonance coils of the power transmission coils to determine values of magnetic resistance and actively selecting the power transmission coil as mentioned above, the following configuration may be employed. That is, a current is passively controlled to flow to the resonance coil of the power receiving coil from the power transmission coil having the resonance coil with the smallest value of magnetic resistance intensively.

Alternatively, the wireless power transfer apparatus may be configured to select a power transmission coil operated with the largest power when the power is actually supplied from the power receiving coil to the load. Also in this case, first, with the power receiver 7 being placed between the first power transmission unit 5 and the second power transmission unit 6, power is transferred from the power transmission coils 1a to 1d formed in the first power transmission unit 5 one by one. The power received by the power receiving coil 3 from each power transmission coil 1 is measured. Next, power is transferred from the power transmission coils 9 formed in the second power transmission unit 6 one by one (only one power transmission coil in FIG. 1), and the power received by the power receiving coil 3 from each power transmission coil 9 is measured to determine the power transmission coil that transmitted the largest power to the power receiving coil 3. In the end, in view of the position of the determined power transmission coil, power is transferred from one power transmission coil or simultaneously from two given power transmission coils in the same plane that are adjacent to each other, which are nearest to the power receiving coil.

### Embodiment 8

FIG. 25 is a cross-sectional view showing the configuration of a magnetic field resonance-type wireless power transfer apparatus according to Embodiment 8. This wireless power transfer apparatus includes a music box shaped (box shaped) housing 20, and a lid 21 that can be opened and closed. The first power transmission unit 5 is held in the housing 20 and the second power transmission unit 6 is held by the lid 21. A portable phone as the power receiver 7 can be placed above the first power transmission unit 5. The power receiver 7 is placed between the first power transmission unit 5 and the second power transmission unit 6 by closing the lid 21. The power receiver 7 is equipped with a charger and the like.

The housing 20 is provided with a high-frequency power driver 22 for converting power received from an AC supply (AC 100V) into transferable power, a control circuit 23 for impedance matching, and the like. Furthermore, an electromagnetic shielding material 24 is placed to encompass the surroundings of the area in which the first power transmission unit 5 and the second power transmission unit 6 are placed. The surroundings of the first power transmission unit 5 and the second power transmission unit 6 are completely shielded electromagnetically when the lid 21 is closed. This prevents electromagnetic waves from affecting the human body and assures safety.

The lid 21 is provided with a display 25 on the surface. The display 25 is provided mainly for displaying the state of charge of a portable phone, information on incoming emails, and the like. LED lamps may be used in place of the display 25. Further, the wireless power transfer apparatus is provided with a protrusion 26 for providing an interlock function. Thus, power transfer does not start unless the lid 21 is completely closed.

The number of power transmission coils forming each of the first power transmission unit 5 and the second power transmission unit 6 is one or more, and the total number of the power transmission coils can be changed in accordance with a variety of forms. Each power transmission coil can be configured to include a loop coil and a resonance coil. The loop coils used in this apparatus are dielectric elements that are excited by electric signals supplied from the high-frequency power driver 22 and transfer the electric signals to the resonance coils. That is, the loop coils couple the high-frequency power driver 22 and the resonance coils by an electromagnetic induction. Further, the resonance coils produce a magnetic field based on the electric signals outputted from the loop coils. The magnetic field strength of the resonance coils becomes the largest at a resonance frequency. Further, the control circuit 23 may include a circuit used for obtaining high transmission efficiency by controlling the coupling coefficient and Q values when the position of the power receiving coil of the power receiver 7 and the resonance frequency are changed, a circuit for exchanging information with the power receiver 7, or a circuit for obtaining the information on the position of the power receiver 7.

The power receiver 7 includes the power receiving coil composed of a loop coil and a resonance coil, a control circuit for impedance matching, a rectifier for converting AC to DC, a load (e.g., charger), and the like.

As described above, it is preferable to electromagnetically shield the entire housing 20 to prevent the influence of a magnetic field generated in the housing 20 from leaking out. The entire housing 20 may be shielded, in principle, to prevent radio waves in a band of several MHz to several hundred MHz as a resonance frequency band from leaking out, but may be shielded, as the case may be, to prevent radio waves in all of frequency bands from leaking out. However, shielding all of frequency bands impose inconveniences when charging a battery of a mobile device such as a portable phone. For this reason, it is desirable that radio waves in a several GHz band used by portable phones and the like can be communicated between the inside and the outside of the housing. Specifically, a relay connector may be imbedded in one side of the housing.

Although the music box shaped housing 20 is used in this embodiment, similar effects can be obtained by a drawer type housing. Further, although the embodiment is described with respect to a small device, such as a portable phone, as an example of the power receiver 7, it is needless to say that the present invention can be applied to a large power receiver such as an electric vehicle.

As described above, the present invention allows favorable power transfer regardless of the position of the power receiving coil. Moreover, the present invention is preferable because the possible power transmission area can be increased more so than the conventional example and thus the application range can be broadened.

The invention may be embodied in other forms without departing from the spirit or essential characteristics thereof. The embodiments disclosed in this application are to be considered in all respects as illustrative and not limiting. The scope of the invention is indicated by the appended claims rather than by the foregoing description, and all changes which come within the meaning and range of equivalency of the claims are intended to be embraced therein.

What is claimed is:

1. A wireless power transfer apparatus comprising a power transmission coil configured to transfer an electric power to a power receiver having a power receiving coil, thereby transferring an electric power to the power receiver through an interaction between the power transmission coil and the power receiving coil, further comprising:
a housing that holds the power transmission coil and forms an interior in which the power receiver can be placed removably;
a lid provided to the housing so as to open and close the interior with the power receiver being placed; and
an electromagnetic shield encompassing the surroundings of the power transmission coil and the power receiving coil at least when an electric power is transferred to the power receiving coil from the power transmission coil,
wherein an electric power is transferred to the power receiving coil from the power transmission coil with the lid of the housing being closed.

2. The wireless power transfer apparatus according to claim 1, wherein the power transmission coil can be arranged so as to take a power transmission arrangement for transferring power to the placed power receiver,
the housing has an interlock function to maintain the power transmission arrangement, and
the interlock function maintains the surroundings of the power transmission coil and the power receiving coil to be electromagnetically shielded during power transfer.

3. The wireless power transfer apparatus according to claim 1, further comprising:
a first power transmission unit in which one or more of the power transmission coils are arranged in the same plane so as not to overlap one another;
a second power transmission unit in which one or more of the power transmission coils are arranged in the same plane so as not to overlap one another;
wherein the first power transmission unit and the second power transmission unit oppose each other to form a power receiving space therebetween in which the power receiver can be placed,
the housing is configured to hold the first power transmission unit and the second power transmission unit, so that the power receiver can be placed in the power receiving space,
the central axis of the one or more power transmission coils included in the first power transmission unit and the central axis of the one or more power transmission coils included in the second power transmission unit are displaced from each other, and
the electromagnetic shield encompasses the surroundings of the first power transmission unit, the second power transmission unit, and the power receiving coil when at least one of the first power transmission unit and the second power transmission unit transfers power to the power receiving coil.

4. The wireless power transfer apparatus according to claim 3, further comprising a controller for controlling power transfer from the power transmission coil,
wherein the controller controls the power transmission coil included in at least one of the first power transmission unit and the second power transmission unit to transfer power to the power receiving coil with the power receiver being placed in the power receiving space.

5. The wireless power transfer apparatus according to claim 3, further comprising a controller for controlling power transfer by the power transmission coil,
wherein the controller has a function to control a plurality of any power transmission coils arranged in at least one of the first power transmission unit and the second power transmission unit to transfer power at the same time.

6. The wireless power transfer apparatus according to claim 4, further comprising a monitoring portion for detecting the position of the power receiving coil,
wherein the controller controls the power transmission coil selected in accordance with the detected position of the power receiving coil to transfer power.

7. The wireless power transfer apparatus according to claim 5, further comprising a monitoring portion for detecting the position of the power receiving coil,
wherein the controller controls the power transmission coil selected in accordance with the detected position of the power receiving coil to transfer power.

8. The wireless power transfer apparatus according to claim 3, wherein the power transmission coil included in the first power transmission unit and the power transmission coil included in the second power transmission unit have the same diameter, and the maximum displacement between the central axis of the power transmission coil included in the first power transmission coil and the central axis of the power transmission coil included in the second power transmission unit is equal to the diameter of each power transmission coil.
